(19) United States
(12) Patent Application Publication
(10) Pub. No.: US 2025/0005590 A1
(43) Pub. Date: Jan. 2, 2025

(54) DOMAIN ADAPTION FOR SERVICE REQUESTS USING A GENERATIVE ADVERSARIAL NETWORK

(71) Applicant: Oracle International Corporation, Redwood Shores, CA (US)

(72) Inventors: Praphul Singh, Pleasanton, CA (US); Rao Akella, San Leandro, CA (US); Subramanyam Iyer, Pleasanton, CA (US)

(73) Assignee: Oracle International Corporation, Redwood Shores, CA (US)

(21) Appl. No.: 18/342,589

(22) Filed: Jun. 27, 2023

(51) Int. Cl. G06Q 30/016

(52) U.S. Cl. CPC G06Q 30/016

(57) ABSTRACT

Techniques for processing incomplete service requests are disclosed. A system identifies reference service requests similar to the information of an incomplete service request received from a user. Using an adversarial domain adapter, the system generates an enhanced service augmenting the incomplete service request with predicted information. The system then identifies a subset of the reference service requests meeting a similarity threshold with the enhanced service request. The system processes the incomplete service request based on the subset of the set of reference service requests.

### TECHNICAL FIELD

The present disclosure relates to responding to service requests. In particular, the present disclosure relates to augmenting service request using a generative adversarial network.

### BACKGROUND

Enterprise service management systems allow users to submit service requests for resolving issues with products and services. To expedite resolution of the service requests, a service management system may enable the users to reference a library of past service requests to identify related requests that have been previously resolved. However, a user's service request may initially contain limited information, such as a product identifier and symptom. Searching an expansive library of the service requests based on such limited information may yield a large quantity of irrelevant results.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a functional block diagram of an example system environment in accordance with one or more embodiments.

FIG. 2 illustrates a block diagram of an example service management system in accordance with one or more embodiments.

FIGS. 3A and 3B illustrate a set of operations of an example process for processing incomplete service requests in accordance with one or more embodiments.

FIGS. 4A and 4B illustrate a set of operations of an example process for training an adversarial domain adapter in accordance with one or more embodiments.

FIG. 5 shows a block diagram illustrating an example computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram in order to avoid unnecessarily obscuring the present invention.
1. GENERAL OVERVIEW
2. SERVICE REQUEST PROCESSING ENVIRONMENT
3. SERVICE MANAGEMENT SYSTEM ARCHITECTURE
4. PROCESSING INCOMPLETE SERVICE REQUESTS
5. TRAINING AN ADVERSARIAL DOMAIN ADAPTER
6. HARDWARE OVERVIEW
7. MISCELLANEOUS; EXTENSIONS

### 1. General Overview

One or more embodiments improve the processing of service requests in an early stage of service request lifecycle. Typically, limited information is available for a service request when the service request is in an early stage of a service request lifecycle. As an example, the service request may be associated with a summary and a description. However, the service request may not be associated with (a) a resource that is used for addressing the service request, (b) components that are affected by a problem identified in a service request, or (c) various types of events during a lifecycle of the service request.

One or more embodiments identify a set of reference service requests meeting a similarity threshold in relation to the limited information corresponding to a service request in an early stage. The limited information, corresponding to the service request, may be referred to as an incomplete feature set corresponding to the service request. The service request in the early stage may be referred to as an initial service request. The system uses (a) an adversarial domain adapter and (b) the set of reference service requests, matched with the initial service request, to predict values for augmenting the incomplete feature set of the service request. Using the augmented features set, the system generates an enhanced service request. The system then identifies a subset of the set of reference service requests meeting a similarity threshold with the enhanced service request. The system then processes the initial service request based on the subset of the set of reference service requests meeting the similarity threshold with the enhanced service request.

One or more embodiments described in this Specification and/or recited in the claims may not be included in this General Overview section.

### 2. Service Request Processing Environment

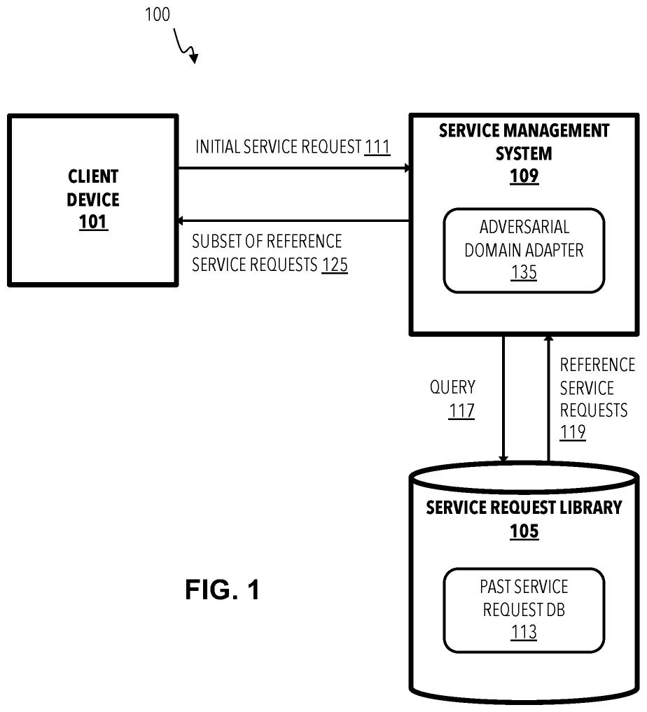

FIG. 1 shows a functional flow block diagram illustrating an example environment 100 for implementing systems and processes in accordance with one or more embodiments. The example environment 100 includes one or more client devices 101, a service request library 105, and a service management system 109, which can be communicatively connected via one or more c 3 communication links. The communication links can be wired and/or wireless information channels, such as the Internet, an intranet, an Ethernet network, a wireline network, a wireless network, a mobile communications network, and/or another communication network. While the components in FIG. 1 are illustrated as separate, it is understood that the components may be local to or remote from each other. Each component may be distributed over multiple applications and/or machines. Multiple components may be combined into one application and/or machine. Operations described with respect to one component may instead be performed by another component.

The client device 101 can be a computing device allowing a user to access and interact with the service management system 109. For example, the client device 101 can be, but is not limited to, a personal computer system, server computer system, thin client, thick client, hand-held or laptop device, multiprocessor system, microprocessor-based system, set top box, programmable consumer electronic, network PC, minicomputer system, mainframe computer system, and the like. The client device 101 can include one or more processors that process software or other computer-readable instructions and include a memory to store the software, computer-readable program instructions, and data. The client device 101 can also include a communication device to communicate with the service management system 109 via the communication links. Additionally, the client device 101 can generate a computer-user interface enabling a user to interact with the service management system 109 using input/output devices to create, transmit, receive, and view service requests, such as an initial service request 111.

The service request library 105 can be a storage system that maintains a database 113 of past service requests. In one or more embodiments, the data repository is any type of storage unit and/or device (e.g., a file system, database, collection of tables, or any other storage mechanism) for storing data. Further, the data repository may include multiple different storage units and/or devices. The past service request database 113 can store service requests that have been previously resolved or are in a late stage of processing. As such, the past service requests in the database 113 can have a complete set of features or substantially complete set of features. For example, service request records in the past service request database 113 can have a set of fields entirely populated with information or almost entirely populated with information.

The service management system 109 can be any type of computing platform providing customer support, troubleshooting, and maintenance services. The service management system 109 can receive an initial service request 111 from the client device 101. The initial service request 111 can be transmitted from the client device 101 using a communication channel, such as a phone call, a text message, an email, a chatbot, or an online form. The initial service request 111 can be any type of communication requesting assistance, support, or specific services from the service management system 109 and can include information supporting the request. For example, the initial service request 111 can identify a customer, a product, and an issue with the product. The service management system 109 can ingest the initial service request 111 into a service request record. For example, using voice recognition, text recognition, bag of words searching, manual data entry, and the like, the service management system 109 can populate fields of a record with the information generated from the initial service request 111. Records for service requests can comprise a set of fields describing the receipt, troubleshooting, resolution, and closure of a service request. For example, the records can include some or all of the following fields: reference number, request receipt time and date, customer identifier, customer contact information, product/service identifier, product serial number, incident description, problem code, problem categorization (e.g., hardware issue, software error, network problem, or the like), customer service agent identifier, service group identifier, technician identifier, priority (e.g., low, medium, high, or urgent), troubleshooting steps taken, troubleshooting results, resolution steps, and ticket closure information. The problem description can be information describing faults, symptoms, and error messages. The troubleshooting steps can include a chronological list of the actions, procedures, tests, and changes performed to diagnose or resolve the problem. The troubleshooting results can include outcomes of the actions, procedures, tests, and changes, including any observations, error messages, or diagnostic information. The resolution can describe any solutions of the problem or workarounds implemented to resolve the problem, including fixes applied, parts replaced, settings changed, or any other actions taken to repair or mitigate the problem. It is understood that service request records are not limited to the above entries and that service request records can include other entries, such as notes, comments, observations, customer satisfaction information, escalation information, context-specific information, and the like.

A record of the initial service request 111 may include information obtained from the client device 101 and information generated by the service management system 109 in response to receiving the initial service request 111. For example, a record of the initial service request 111 may be associated with a ticket number, a receipt time, a receipt date, a customer identifier, ¢ 5 customer contact information, a product/service identifier, a product serial number, an incident description, and a customer service agent identifier. However, as the no investigation or resolution of the problem included in the initial service request will have occurred at the time when the initial service request 111 was received, the record generated for the initial service request 111 will lack complete information generated by subsequent troubleshooting, resolution, and/or closure of the service request. For example, the record may lack information in entries corresponding to troubleshooting steps, troubleshooting results, and resolution steps.

Additionally, in response the initial service request 111, the service management system 109 can use the information in the record of the initial service request 111 to generate and execute a query 117 to retrieve reference service requests 119 from the service request library 105. As described above, the service request library 105 can maintain a database 113 of past service requests that have been resolved and/or closed. Accordingly, the records of the past service requests are complete such that all or substantially all of the entries included in the records are populated with information. In response to the query 117, the service request library 105 can return a set of reference service requests 119 similar to the initial service request 111. For example, the set of reference service requests 119 can be determined using a cosine similarity function.

The service management system 109 can process the initial service request 111 and the set of reference service request 119 using an adversarial domain adapter 135 to generate an enhanced service request including predicted features augmenting the information of the initial service request 111. The adversarial domain adapter 135 uses information from the reference service requests 119, which have complete data, to generate synthetic data for enhancing new service requests, which lack complete data. Some embodiments of the adversarial domain adapter 135 are deep learning models trained to perform natural language processing that generate synthetic data from the data in the reference service requests 119. For example, the adversarial domain adapter 135 can be a sequence-to-vector model (e.g., Seq2Vector). A sequence-to-vector model is a neural network architecture that takes a sequence of input data and outputs a fixed-length vector representation. It is understood that some embodiments can use other models that generate vectors, such as a sequence-to-sequence model (e.g., Seq2Seq). The synthetic data can be combined with the initial service request 111 to construct an enhanced service request. The entries of the enhanced service request can be populated with information representing a predicted path of the initial service request 111 based on the incomplete information included in the record of the initial service request 111.

Using the enhanced service request, the service management system 109 identifies a subset of the reference service requests 125 from the set of reference service requests 119 meeting similarity criteria with the enhanced service request. Because the subset of the reference service requests 125 is determined using the enhanced service request, the subset of the reference service requests 125 will include a smaller quantity of more relevant service requests than the set of reference service requests 119. The service management system 109 can process the subset of the reference service requests 125 and transmit it to the client device 101 for presentation to a user. The user of the client device 101 and a technician of the service management system 109 can refer to the subset of the reference service requests 125 to troubleshoot the issue identified in the initial service request 111.

In a non-limiting example, a user can access the service management system 109 using the client device 101 to submit the initial service request 111 related to a fluid dispenser having a leaking tank. Initially, a record of the initial service request 111 may contain limited information, such as a ticket number, a user identifier, user contact information, product information of the fluid dispenser, and a description of the tank leak. Based on the forgoing information of the initial service request 111, the service management system 109 can execute query 117 on the service request library 105 and retrieve the set of reference service requests 119 similar to the initial service request 111 from the past service request database 113. Because the initial service request 111 may lack information they may be uncovered in subsequent troubleshooting, such as an age of the fluid dispenser, a location of leak, a type of fluid, or the like, the retrieved set of reference service requests 119 may include a large number of records remotely related to the actual problem that triggered the initial service request 111. For example, the set of reference service requests 119 might include a large variety of records of past service requests related to, for example: dispenser products having failed gaskets, dispenser products having failed pump mechanisms, dispenser products having clogged nozzles, fluid tanks having cracked housings, and fluid tanks having damaged collars or caps, and so on. However, few of these reference service requests 119 may actually be helpful in processing and solving the user's service issue. Additionally, a ranking of the set of reference service requests 119 may be inaccurate and, therefore, misleading as to the solution. Embodiments refine the set of reference service requests 119 using the adversarial domain adapter 135 to generate an enhanced service request. As described above, the enhanced service request includes predicted features augmenting the information of the initial service request 111. Then, the service management system 109 identifies a subset of the set of reference service requests 119 similar to the enhanced service request. Because the enhanced service request includes additional features augmenting the initial service request, the quantity of reference service requests included in the subset 125 is substantially smaller than in the original set of reference service requests 119. Additionally, the similarity between the subset of references service requests and the initial service request may be substantially greater than the similarity between the original set of reference service requests 119 and the initial service request 111. Accordingly, embodiments improve functioning of the service management system in processing and responding to service requests by increasing the efficiency, relevance, and ranking of the identified reference service requests.

### 3. Service Management System Architecture

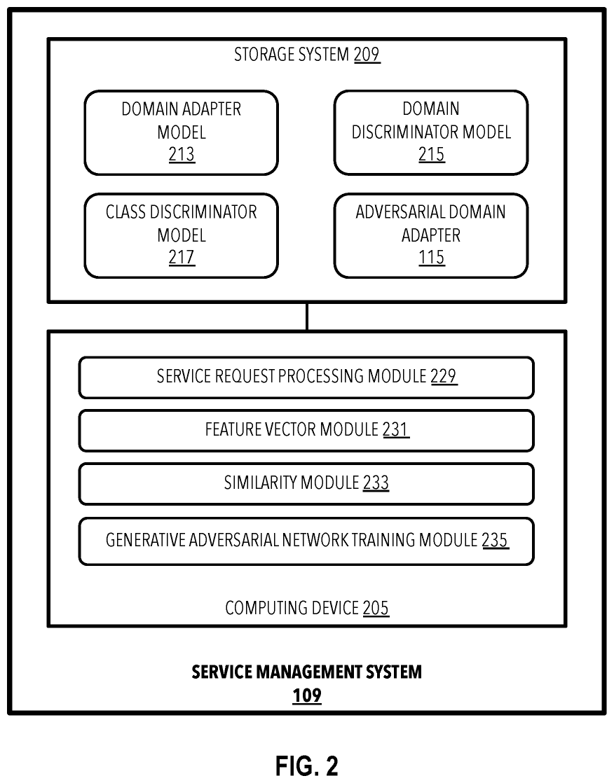

FIG. 2 shows a system block diagram illustrating an example of a service management system 109 in accordance with one or more embodiments. The service management system 109 can be the same or similar to that described above. The service management system 109 includes hardware and software that perform processes and functions disclosed herein. The service management system 109 can include a computing device 205 and a storage system 209. The computing device 205 can include one or more processors (e.g., microprocessor, microchip, or application-specific integrated circuit) and one or more computer-readable memories (e.g., random access memory, read only memory, flash memory, etc.)

The storage system 209 can comprise one or more non-transitory computer-readable, hardware storage devices that store information and program instructions used by the processes and functions disclosed herein. For example, the storage system 209 can include one or more flash drives and/or hard disk drives. One or more embodiments of the storage system 209 stores domain adapter model 213, a domain discriminator model 215, and a class discriminator model 217. Additionally, the storage system 209 can store an adversarial domain adapter 115, which can be the same as that previously described above. As described in greater detail, the domain adapter model 213, the domain discriminator model 215, and the class discriminator model 217 can be used in a generative adversarial network (GAN) process to train the adversarial domain adapter 115 to determine enhanced service requests predicting features of incomplete service requests (e.g., initial service request 111). Some embodiments of the domain discriminator model 215, and a class discriminator model 217 are dense neural networks trained to predict whether a vector output by the domain adapter model 213 is synthetic based on reference search requests (e.g., reference search requests 119).

In embodiments, the computing device 205 includes one or more processors (e.g., microprocessor, microchip, or application-specific integrated circuit), one or more memory devices (e.g., RAM and ROM), one or more I/O interfaces, and one or more network interfaces. The memory device can include a local memory (e.g., a random-access memory and a cache memory) employed during execution of program instructions. Additionally, the computing device 205 includes at least one communication channel (e.g., a data bus) by which it communicates with the I/O device and the storage system 209. The computing device 205 executes computer program instructions (e.g., an operating system and/or application programs), which can be stored in the memory device and/or storage system. The computing device 205 can also execute computer program instructions of a service request processing module 229, a feature vector module 231, a similarity module 233, and a generative adversarial network training module 235.

The service request processing module 229 can be hardware, software, or a combination thereof that processes service requests received from users (e.g., initial service request 111) and generates queries (e.g., query 117) for retrieving reference service requests (e.g., reference service requests 119) similar to the received service requests. Additionally, the service request processing module 229 identifies a subset of the reference service requests based on an enhanced service request including predicted values augmenting the limited information initially included in the received service request.

The feature vector module 231 can generate feature vectors from the contents of service requests. Embodiments of the feature vector module 231 generate feature vectors using transformer-based language models. For example, the feature vector module 231 can generate the feature vectors using the Longformer model. The Longformer model generates vectors by processing long-range dependencies in text using a global attention mechanism that allows the model to attend to distant tokens without relying solely on local attention patterns. By capturing context from both nearby and distant tokens, the Longformer model efficiently transforms records including large numbers of tokens. It is understood that other vector transformation models, such as BERT (Bidirectional Encoder Representations from Transformers), can be used.

The similarity module 233 determines similar service requests based on one or more criteria. Embodiments of the similarity module 233 can determine similar service requests by determining a cosine similarity. Additionally, embodiments of the similarity module 233 can determine similar service requests by determining a probabilistic similarity.

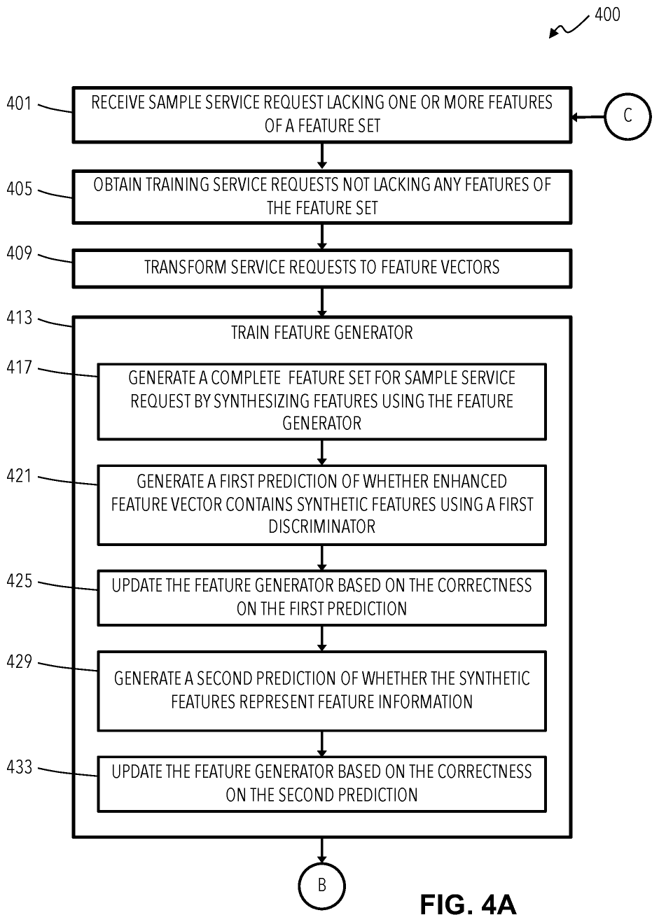

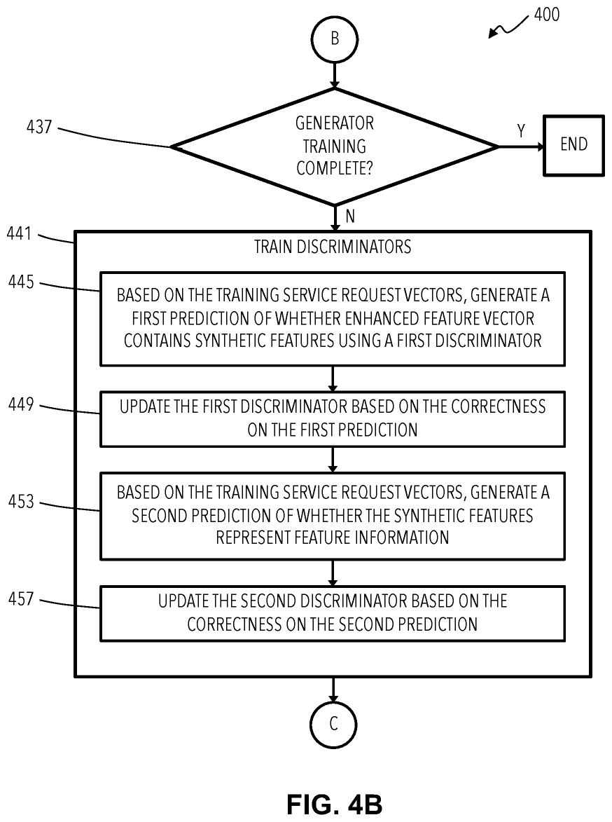

The generative adversarial network training module 235 generates the adversarial domain adapter 115 by performing a generative adversarial network process. As described below regarding FIGS. 4A and 4B, the generative adversarial network process iteratively performs a first training cycle of the domain adapter model 213 using outputs of the domain discriminator model 215 and the class discriminator model 217, and a second training cycle of the domain discriminator model 215 and the class discriminator model 217 using the output of the domain adapter model 213.

It is noted that the computing device 205 can comprise any general-purpose computing article of manufacture capable of executing computer program instructions installed thereon (e.g., a personal computer, server, etc.). However, the computing device 205 is only representative of various possible equivalent-computing devices that can perform the processes described herein. To this extent, in embodiments, the functionality provided by the computing device 205 can be any combination of general and/or specific purpose hardware and/or computer program instructions. In each embodiment, the program instructions and hardware can be created using standard programming and engineering techniques, respectively.

The components illustrated in FIG. 2 may be implemented in software and/or hardware. Each component may be distributed over multiple applications and/or machines. Multiple components may be combined into one application and/or machine. Operations described with respect to one component may instead be performed by another component.

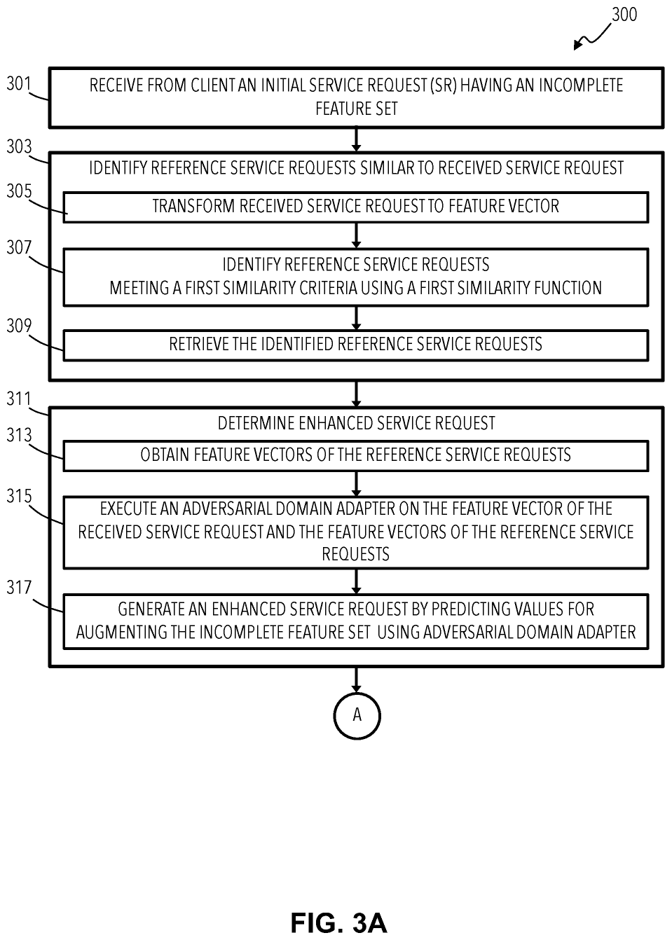

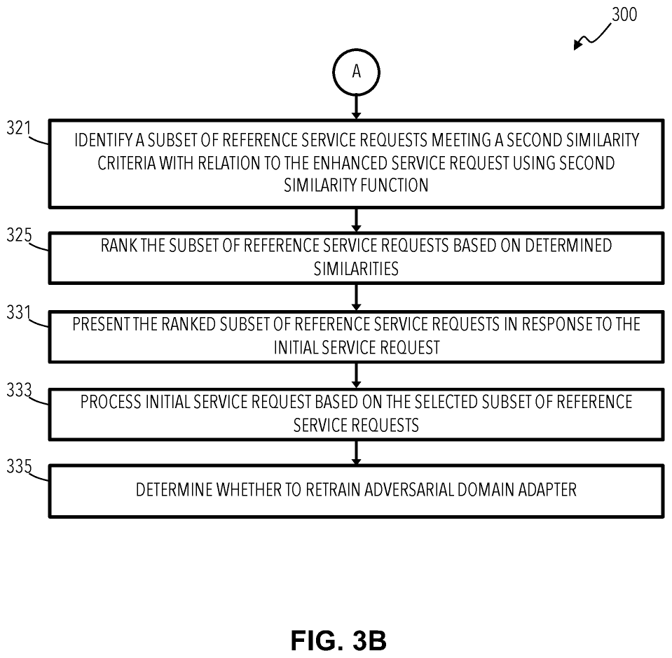

The flow diagrams in FIGS. 3A, 3B, 4A, and 4B illustrate functionality and operations of systems, devices, processes, and computer program products according to various implementations of the present disclosure. Each block in FIGS. 3, 4A, and 4B can represent a module, segment, or portion of program instructions, which includes one or more computer executable instructions for implementing the illustrated functions and operations. In some implementations, the functions and/or operations illustrated in a particular block of the flow diagrams can occur out of the order shown in FIGS. 3A, 3B, 4A, and 4B. For example, two blocks shown in succession can be executed substantially concurrently, or the blocks can sometimes be executed in the reverse order, depending upon the functionality involved. Additionally, in some implementations, the blocks of the flow diagrams can be rearranged in different orders. Further, in some implementations, the flow diagram can include fewer blocks or additional blocks. It is also noted that each block of the flow diagrams and combinations of blocks in the flow diagrams can be implemented by special-purpose hardware-based systems that perform the specified functions or acts, or combinations of special-purpose hardware and computer instructions. Accordingly, the particular sequence of operations illustrated in FIGS. 3A, 3B, 4A, and 4B should not be construed as limiting the scope of one or more embodiments.

### 4. Processing Incomplete Service Requests

FIGS. 3A and 3B illustrate a set of operations of an example process 300 for processing incomplete service requests in accordance with one or more embodiments. At block 301, a system (e.g., service management system 109 executing service request processing module 229) receives from a client (e.g., client device 101) an initial service request (e.g., initial service request 111) having an incomplete feature set. As described above, the feature set of a service request is incomplete when a record populated with information generated for the service requests has missing information. For example, the record can include a predetermined set of entries (e.g., 15 fields) corresponding to features, of which the initial service request includes information sufficient to populate some entries (e.g., request receipt time and date, customer identifier, customer contact information, product/service identifier, product serial number, problem description), but lacks information for some other fields related to, for example, troubleshooting and resolving a problem identified in the initial service request (e.g., problem code, incident categorization, service group identifier, technician identifier, priority, troubleshooting steps taken, troubleshooting results, and ticket closure information).

At block 303, the system identifies reference service requests (e.g., reference service requests 119) similar to the initial service request received at block 301. Identifying the reference service requests can include, at block 305, transforming (e.g., by executing feature vector module 231) the initial service request to a feature vector. The feature vector module 231 can generate the feature vectors from the contents of the initial service request using, for example, Longformer, BERT, or the like.

Identifying the reference requests can include, at block 307, identifying (e.g., by executing similarity module 233) past service requests (e.g., in past service request database 113) meeting a first criteria using a similarity function. Some embodiments determine the reference service requests using cosine similarity, which determines the cosine of the angle between two vectors and determines whether the two vectors are pointing in a substantially the same direction. Identifying the reference service requests can include, at block 307, retrieving the reference service requests identified at block 307. For example, the system can retrieve reference service requests having a cosine similarity (e.g., angle) less than a predetermined threshold. It is understood that some embodiments can use other similarity functions (e.g., probability) and criteria.

At block 311, the system determines an enhanced service request. Determining the enhanced service request can include, at block 313, obtaining feature vectors of the reference service requests identified at block 303. The feature vectors of the reference service requests can be predetermined or can be determined in a same or similar manner to that of block 305. Determining the enhanced service request can also include, at block 315, executing an adversarial domain adapter (e.g., adversarial domain adapter 115) on the feature vector of the received service request and the feature vectors of the reference service requests. Determining the enhanced service request can further include, at block 317, generating an enhanced service request by predicting values for augmenting the incomplete feature set of the received service request using the adversarial domain adapter. For example, the system can predict values of a feature vector for the information not included in the record of the received service request (e.g., problem code, incident categorization, service group identifier, technician identifier, priority, troubleshooting steps taken, troubleshooting results, and ticket closure information). The adversarial domain adapter can be trained, as described below regarding FIGS. 4A and 4B, to generate a complete feature set augmented with synthesized features predicted based on the reference service requests.

Referring to FIG. 3B, as indicated by off-page connector “A,” at block 321, the system identifies (e.g., by executing similarity module 233) a subset of the reference service requests (e.g., subset of the reference service requests 125) identified at block 303 meeting a similarity criteria in relation to the enhanced service request determined at block 311 using a similarity function. The similarity function can be, for example, a probability search function, which identifies information based on a likelihood of relevance. Probability searching assigns weights to different outcomes and using those probabilities to guide the search process. The criteria can be a likelihood of relevance being greater than a predetermined threshold. It is understood that some embodiments can user other similarity functions (e.g., cosine) and criteria. At block 325, the system ranks the subset of reference service requests based on the similarities determined at block 321. Some embodiments identify the subset by selecting a predetermined number of reference service requests having the highest rank, such as the top ten highest ranking service requests.

At block 331, the system presents the selected subset of reference service requests in response to the initial service request received at block 301. Presenting the subset of reference service requests can involve transmitting the subset in response to the initial service request and presenting the subset by the client device. For example, based on the reference service requests presented at the client device, the user can more efficiently identify and pursue potential solutions to the problem included in the initial service request. At block 333, the system processes the initial service request based on the subset of reference service requests. Processing the initial service request can include directing the service request to a product group, a service group, or a technician predicted by the enhanced service request. Additionally, processing the initial service request can include recommending troubleshooting and resolution steps based on the subset of reference service requests. For example, a technician can quickly identify and recommend solutions to the problem identified in the initial service request based on the resolutions identified in the identified subset of reference service requests.

At block 335, the system can determine whether to retrain the adversarial domain adapter. The retraining determination can be based on the enhanced service request determined at block 311. Some embodiments determine error of the enhanced service request using a domain discriminator model (e.g., domain discriminator model 215) and/or class discriminator model (e.g., class discriminator model 217). When the error output by one or both of the models exceeds a predetermined threshold, the system can cause the adversarial domain adapter to be retrained using updated reference service requests, as described below regarding FIGS. 4A and 4B. By doing so, the system can tune the adversarial domain adapter to adapt to drift in the content of the reference service requests over time.

### 5. Training an Adversarial Domain Adapter

FIGS. 4A and 4B illustrate a set of operations of an example process 400 for training an adversarial domain adapter (e.g., adversarial domain adapter 115) in accordance with one or more embodiments. At block 401, the system (e.g., service management system 109 executing generative adversarial network training module 235) receives a sample service request lacking one or more features of a feature set from training data. The training data can be, for example, obtained from past service requests (e.g., from past service request database 113) having a set of fields entirely populated with information with information. The sample service request can be a service request having an incomplete set of features, which can be similar to the received service request described above (e.g., initial service request 111). The sample service request can be a simulated search request, manually generated by a user, or using generated data. Some embodiments generate sample service requests by extracting information (e.g., fields or entries) from past service request that are typically included in initial service requests. For example, the system can generate a sample service request using a customer, a product, and an issue with the product extracted from a reference service request.

At block 405, the system obtains training service requests not lacking any features of the feature set from the training data (e.g., past service request database 113). The training service requests can be the same or similar to the reference service requests (e.g., reference service requests 119) obtained from a service request library (e.g., service request library 105), as previously described above. At block 409, the system transforms the sample service requests received at block 401 and the training service requests obtained at block 405 to feature vectors. As described above, the system can use a feature generation algorithm, such as Longformer, to generate the feature vectors.

At block 413, the system trains a feature generator (e.g., domain adapter model 213) to construct the enhanced service request from the sample service requests based on the training service requests. Training the feature generator can include, at block 417, generating a complete feature set for the sample service request by synthesizing features using the feature generator. The feature generator receives a sample service request as an input and applies one or more transformations to construct the enhanced service requests. Some embodiments construct the enhanced service request by predicting information to complete the sample service request using, for example, a sequence-to-vector model (e.g., Seq2Vector) trained to receive a labeled first sequence and generate a different, second sequence consistent with the label applied to the first sequence conforming to the statistical properties or distribution of data in the training service requests.

Training the feature generator can also include, at block 421, generating a prediction of whether the enhanced service request contains synthetic features using a domain discriminator model (e.g., domain discriminator model 215). The domain discriminator model predicts whether the properties and or characteristics included in the complete feature set generated at block 417 are synthetic or not based on the training service requests obtained at block 405. For example, the domain discriminator model can determine whether a service group identifier included in the feature vector represents an actual service group identifier. Based on the correctness of the prediction of whether the synthesized features are real or synthetic, the system feeds back a loss to train the feature generator. Training the feature generator can further include, at block 425, updating parameters the feature generator based on the correctness on the first prediction by the domain discriminator model.

Training the feature generator can also include, at block 429, generating a prediction of whether the features of the enhanced service request represent synthetic features using a class discriminator model (e.g., class discriminator model 217). The class discriminator model predicts whether categories of features included in the feature vector generated at block 417 are synthetic or not in comparison to the training service requests obtained at block 405. Determining whether the feature vector is synthetic can include determining a probability or score for each sample, indicating a perceived likelihood of the enhanced service request being a training service request. For example the prediction can be based on whether the feature vector lacks class-specific information. The domain discriminator can determine whether the feature vector lacks information corresponding to a problem code, an incident categorization, a service group identifier, a technician identifier, a priority, a troubleshooting step, a troubleshooting result, and a ticket closure, or the like.

Training the feature generator can further include, at block 433 updating the feature generator based on the correctness of the second prediction as block 429. The system can determine error or loss based on the discriminator's classification results. Various loss functions, such as mean squared error, can be used to quantify the difference between the discriminator's predictions and the training service requests. The error signal is used as feedback to update parameters of the feature generator, such as weights and biases. As described previously, the feature generator generates samples that can “fool” the discriminators into classifying them as training service requests. By minimizing the error signal received from the discriminator, the feature generator adjusts its parameters to produce higher-quality feature vectors.

Continuing to FIG. 4B as indicated by off-page connector “B,” at block 437, the system determines whether the feature generator training is complete. The system can determine that the training is complete when the error signal determined at block 433 is minimized. If so (e.g., block 437 is “Yes”), then the process 400 ends. If not (e.g., block 437 is “No”), then at block 441, the system trains the domain discriminator model and the class discriminator model. Training the discriminators can include, at block 445, based on the training service request vectors, generating a prediction of whether the synthetic feature set generated at block 417 represents synthetic or real feature information using the class discriminator model.

Training the discriminators can also include, at block 457, updating the class discriminator model based on the correctness on the prediction generated at block 421. The error or loss can be computed based on the discriminator's classification results. A loss function, such as mean square error, to quantify the discrepancy between the discriminator's predictions and the true classification of the feature vector. The error signal can be backpropagated through the discriminator's model to update the weight and bias parameters.

Training the discriminators can include, at block 453, based on the training service request vectors, generating a prediction of whether the feature set generated at block 417 contains synthetic or real features using the domain discriminator model. The system evaluates generated samples and produces a probability or score for each sample, indicating its perceived likelihood of belonging to the source domain. Training the discriminators can further include, at block 457, updating the domain discriminator model based on the correctness on the prediction generated at block 429. The error or loss is computed in a same or similar manner to that described at block 445.

Responsive to updating the class and domain discriminator, the process 400 iteratively returns to block 401, as indicated by off-page connector “C” to continue training the feature generator until the system determines training is complete at block 437. The process 400 can alternately train the feature generator, as described in block 413, and train the discriminators, as described in block 441, until the discriminators can no longer discriminate between actual features or synthetic features generated by the feature generator.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

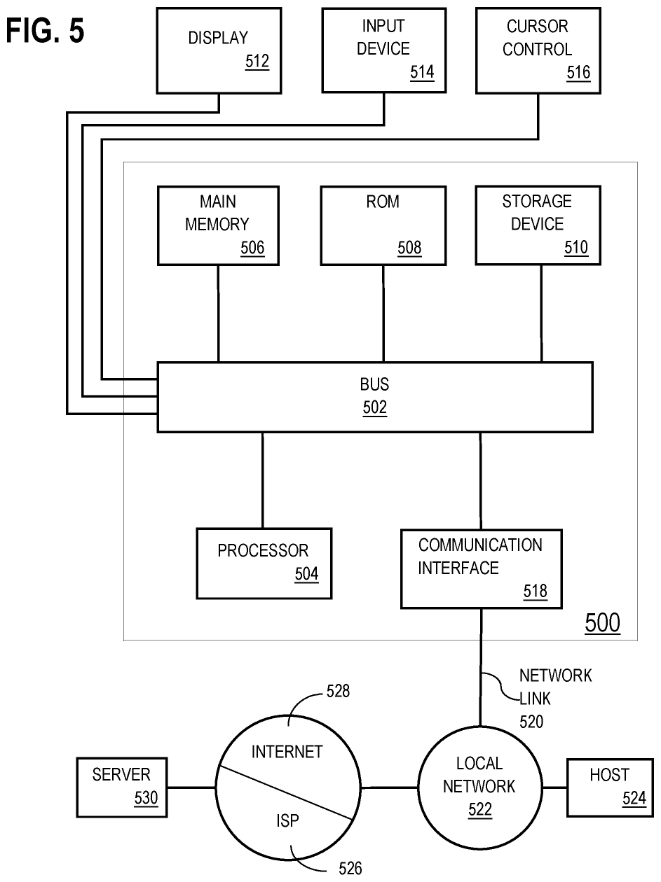

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing program instructions that, when executed by one or more hardware processors, cause performance of operations comprising:
receiving an initial service request comprising an incomplete feature set;
identifying a plurality of reference service requests meeting a first similarity criteria with relation to the initial service request based on (a) the incomplete feature set of the initial service request and (b) a plurality of features sets corresponding respectively the plurality of reference service requests;
using an adversarial domain adapter and the plurality of reference service requests to predict values for augmenting the incomplete feature set of the initial service request to generate an enhanced service request with an updated feature set;
identifying a subset of reference service requests, of the plurality of reference service requests, meeting a second similarity criteria with relation to the enhanced service request based on (a) the updated feature set of the enhanced service request and (b) a subset of the plurality of features sets corresponding respectively the subset of reference service requests; and
processing the initial service request based on the subset of the reference service requests.

2. The one or more non-transitory computer-readable media of claim 1, wherein the feature set of the enhanced service request includes:
a first subset of features included in the feature set of the initial service request, and
a second subset of features generated by the adversarial domain adapter.

3. The one or more non-transitory computer-readable media of claim 1, wherein identifying a plurality of reference service requests comprises determining a cosine similarity between the incomplete feature set of the initial service request and the respective features sets of the plurality of reference service requests.

4. The one or more non-transitory computer-readable media of claim 1, wherein identifying a subset of reference service requests: determining similarities between the feature set of the enhanced service request and the respective features sets of the plurality of reference service requests using a probability-based similarity function.

5. The one or more non-transitory computer-readable media of claim 1, wherein selecting the subset of the reference service requests comprises:
ranking the plurality of reference service requests based on the similarities between the updated feature set of the enhanced service request and the subset of the plurality of features sets corresponding respectively the subset of reference service requests; and
selecting a subset of the reference service requests based on the ranking.

6. The one or more non-transitory computer-readable media of claim 1, wherein the initial service request comprises an unresolved service request submitted to a provider of a product or a service.

7. The one or more non-transitory computer-readable media of claim 6, wherein the plurality of reference service requests comprise service requests previously resolved by the provider.

8. The one or more non-transitory computer-readable media of claim 1, wherein the adversarial domain adapter comprises an adversarial domain adapter trained using a generative adversarial network.

9. The one or more non-transitory computer-readable media of claim 1, wherein determining the enhanced service request comprises:
transform the initial service request to a feature vector;
obtaining feature vectors of the plurality of reference service requests; and
generating the features that complete the feature set of the initial service request by executing the adversarial domain adapter on the feature vector of the initial service request and the feature vectors of the plurality of reference service requests.

10. A method comprising:
receiving an initial service request comprising an incomplete feature set;
identifying a plurality of reference service requests meeting a first similarity criteria with relation to the initial service request based on (a) the incomplete feature set of the initial service request and (b) a plurality of features sets corresponding respectively the plurality of reference service requests;
using an adversarial domain adapter and the plurality of reference service requests to predict values for augmenting the incomplete feature set of the initial service request to generate an enhanced service request with an updated feature set;
identifying a subset of reference service requests, of the plurality of reference service requests, meeting a second similarity criteria with relation to the enhanced service request based on (a) the updated feature set of the enhanced service request and (b) a subset of the plurality of features sets corresponding respectively the subset of reference service requests; and
processing the initial service request based on the subset of the reference service requests.

11. The method of claim 10, wherein the feature set of the enhanced service request includes:
a first subset of features included in the feature set of the initial service request, and
a second subset of features generated by the adversarial domain adapter.

12. The method of claim 10, wherein identifying a plurality of reference service requests comprises: determining a cosine similarity between the incomplete feature set of the initial service request and the respective features sets of the plurality of reference service requests.

13. The method of claim 10, wherein identifying a subset of reference service requests:
determining similarities between the feature set of the enhanced service request and the respective features sets of the plurality of reference service requests using a probability-based similarity function.

14. The method of claim 10, wherein selecting the subset of the reference service requests comprises:
ranking the plurality of reference service requests based on the similarities between the updated feature set of the enhanced service request and the subset of the plurality of features sets corresponding respectively the subset of reference service requests; and
selecting a subset of the reference service requests based on the ranking.

15. The method of claim 10, wherein the initial service request comprises an unresolved service request submitted to a provider of a product or a service.

16. The method of claim 15, wherein the plurality of reference service requests comprise service requests previously resolved by the provider.

17. The method of claim 10, wherein the adversarial domain adapter comprises an adversarial domain adapter trained using a generative adversarial network.

18. The method of claim 10, wherein determining the enhanced service request comprises:
transform the initial service request to a feature vector;
obtaining feature vectors of the plurality of reference service requests; and
generating the features that complete the feature set of the initial service request by executing the adversarial domain adapter on the feature vector of the initial service request and the feature vectors of the plurality of reference service requests.

19. A system comprising a hardware processor and computer-readable program instructions that, when executed by the hardware processor, control the system to perform operations, comprising:
receiving an initial service request comprising an incomplete feature set;
identifying a plurality of reference service requests meeting a first similarity criteria with relation to the initial service request based on (a) the incomplete feature set of the initial service request and (b) a plurality of features sets corresponding respectively the plurality of reference service requests;
using an adversarial domain adapter and the plurality of reference service requests to predict values for augmenting the incomplete feature set of the initial service request to generate an enhanced service request with an updated feature set;
identifying a subset of reference service requests, of the plurality of reference service requests, meeting a second similarity criteria with relation to the enhanced service request based on (a) the updated feature set of the enhanced service request and (b) a subset of the plurality of features sets corresponding respectively the subset of reference service requests; and
processing the initial service request based on the subset of the reference service requests.

20. The system of claim 19, wherein the feature set of the enhanced service request includes:
a first subset of features included in the feature set of the initial service request, and
a second subset of features generated by the adversarial domain adapter.

21. The system of claim 19, wherein identifying a plurality of reference service requests comprises: determining a cosine similarity between the incomplete feature set of the initial service request and the respective features sets of the plurality of reference service requests.

22. The system of claim 19, wherein identifying a subset of reference service requests:
determining similarities between the feature set of the enhanced service request and the respective features sets of the plurality of reference service requests using a probability-based similarity function.

23. The system of claim 19, wherein selecting the subset of the reference service requests comprises:
ranking the plurality of reference service requests based on the similarities between the updated feature set of the enhanced service request and the subset of the plurality of features sets corresponding respectively the subset of reference service requests; and
selecting a subset of the reference service requests based on the ranking.

24. The system of claim 19, wherein the initial service request comprises an unresolved service request submitted to a provider of a product or a service.

25. The system of claim 24, wherein the plurality of reference service requests comprise service requests previously resolved by the provider.

26. The system of claim 19, wherein the adversarial domain adapter comprises an adversarial domain adapter trained using a generative adversarial network.

27. The system of claim 19, wherein determining the enhanced service request comprises:
transform the initial service request to a feature vector;
obtaining feature vectors of the plurality of reference service requests; and
generating the features that complete the feature set of the initial service request by executing the adversarial domain adapter on the feature vector of the initial service request and the feature vectors of the plurality of reference service requests.
